(19) United States
(12) Patent Application Publication
(10) Pub. No.: US 2013/0241516 A1
(43) Pub. Date: Sep. 19, 2013

(54) SWITCHING REGULATOR

(71) Applicants: Yusuke Ueno, Osaka (JP); Ippei Noda, Osaka (JP)

(72) Inventors: Yusuke Ueno, Osaka (JP); Ippei Noda, Osaka (JP)

(73) Assignee: RICOH COMPANY, LTD., Tokyo (JP)

(21) Appl. No.: 13/792,479

(22) Filed: Mar. 11, 2013

(30) Foreign Application Priority Data
Mar. 15, 2012 (JP) 2012-058685

(51) Int. Cl. G05F 1/618

(52) U.S. Cl. CPC G05F 1/618
USPC 323/285

(57) ABSTRACT

A switching regulator includes a ripple generating circuit that generates a ripple voltage signal having a voltage that increases when a first switch element is on and decreases when a second switch element is on, or a voltage that decreases when the first switch element is on and increases when the second switch element is on, a comparator that compares the ripple voltage signal to a reference voltage, and generates a comparison signal indicating the comparison result, and a switch element control circuit that generates, according to the comparison signal, a control signal to switch on and off of the first switch element and a control signal to switch on and off of the second switch element, and applies the control signals to the first and second switch elements, respectively, wherein the ripple generating circuit generates the ripple voltage signal based on the control signals.

### CROSS-REFERENCE TO RELATED APPLICATIONS

The present application is based on and claims priority from Japanese Patent Application Number 2012-058685, filed Mar. 15, 2012, the disclosure of which is hereby incorporated by reference herein in its entirety.

### BACKGROUND

The present invention relates to a switching regulator configured to detect ripples of an output voltage, and more particularly relates to a switching regulator having a PWM (Pulse Width Modulation) control mode and a PFM (Pulse Frequency Modulation) control mode, and being capable of switching between the control modes according to load conditions of a CPU and the like.

In recent years, the miniaturization of portable devices has been advanced and a wide variety of applications have been installed loaded into the devices. These trends have brought about a demand for a power circuit which enables use of a smaller external component and is capable of fast response with low power consumption. Particularly, there is an increasing demand for a technique to improve power conversion efficiency by reducing a power loss of the power circuit when the power circuit supplies a small amount of current supplied to a load circuit such as a CPU, i.e., operates under light load.

As control modes of a switching regulator, there have been known the following two modes. One of them is a PWM control mode to obtain a constant output voltage by control of changing a duty cycle of a clock signal having a constant frequency and thus changing on-time of a switching transistor. The other mode is a PFM control mode to obtain a constant output voltage by control of changing a cycle of a clock signal having a constant pulse width and thus changing a switching frequency while fixing the on-time of the switching transistor. Japanese Patent Application Publication No. 2001-332974 discloses a D/A converter having the PWM control mode and the PFM control (pulse density modulation) mode.

Particularly, the PFM control mode is often used as a method for improving power conversion efficiency under light load of the switching regulator. This is because a power loss of the switching regulator is increased in proportion to the switching frequency, and thus the power conversion efficiency can be improved by reducing the switching frequency under light load using the PFM control mode.

FIG. 9 is a circuit diagram showing a configuration of a switching regulator according to a conventional example. The switching regulator shown in FIG. 9 can detect ripples of an output voltage, has the PWM control mode and the PFM control mode, and can switch between the control modes. The switching regulator shown in FIG. 9 includes a switch element Sw1 (first switch element) that is a Pch transistor and a switch element Sw2 (second switch element) that is an Nch transistor. The switch elements Sw1 and Sw2 are series-connected between a voltage source of an input voltage VCC that is a power-supply voltage and a terminal of a ground voltage GND. A comparator 11 compares a divided voltage VF obtained by dividing an output voltage VOUT of the switching regulator (a voltage at a node N2) by resistors Rf1 and Rf2 with a reference voltage VREF1, generates a comparison signal CMPO indicating the result of comparison, and transmits the signal to a switch element control circuit 12. The switch element control circuit 12 generates control signals PDRV and NDRV to switch on and off of the switch elements Sw1 and Sw2 according to the comparison signal CMPO, and applies the control signals PDRV and NDRV to gates of the switch elements Sw1 and Sw2, respectively. A node N1 as a connection point between the switch elements Sw1 and Sw2 is connected to a load 31 through a filter circuit including an inductor L and an output capacitor Cout.

In the switching regulator shown in FIG. 9, when the divided voltage VF becomes smaller than the reference voltage VREF1, the comparison signal CMPO outputted from the comparator 11 becomes high level, and both of the control signals PDRV and NDRV outputted from the switch element control circuit 12 become low level. Thus, the switch element Sw1 is turned on and the switch element Sw2 is turned off.

In this event, an inductor current IL is increased as energy is charged in the inductor L by a difference in potential between the input voltage VCC and the output voltage VOUT. Moreover, the output voltage VOUT is increased by the output capacitor Cout and a series equivalent parasitic resistance Resr (not shown) thereof. Next, upon completion of an on-cycle of the switch element Sw1, both of the control signals PDRV and NDRV become high level. Accordingly, the switch element Sw1 is turned off, and the switch element Sw2 is turned on. In this event, the inductor current IL is decreased as energy is discharged from the inductor L by a difference in potential between the ground voltage GND and the output voltage VOUT. Moreover, the output voltage VOUT is decreased by the output capacitor Cout and the series equivalent parasitic resistance Resr. In this way, the switching regulator shown in FIG. 9 makes an average value VC of the output voltage VOUT be a predetermined voltage by control of repeating turning on and off of the switch elements Sw1 and Sw2.

In the PWM control mode, when the energy stored in the inductor L is all discharged and the inductor current IL becomes 0 during the on-cycle of the switch element Sw2, a current in which charges stored in the output capacitor Cout flows into the ground voltage GND through the switch element Sw2, i.e., a so-called backflow current is generated. Accordingly, the power conversion efficiency of the switching regulator is significantly reduced. The reduction in power conversion efficiency is more prominent particularly under light load since the backflow current is more likely to be generated.

The switching regulator shown in FIG. 9 includes a backflow detecting comparator 13 configured to detect the backflow current. The backflow detecting comparator 13 compares a voltage VLX at the node N1 to the ground voltage GND, generates a backflow detection signal REVO indicating the comparison result (i.e., whether or not a backflow current flowing from the node N1 to the switch element Sw2 is detected), and sends the generated signal to the switch element control circuit 12.

FIG. 10 is a timing chart showing a backflow detecting operation of the switching regulator shown in FIG. 9. In the PFM control mode, as shown in FIG. 10, in order to prevent generation of the backflow current, if the inductor current IL becomes 0 and the voltage VLX at the node N1 becomes 0 during the on-cycle of the switch element Sw2 (when the control signal NDRV is at a high level), a backflow detection signal REVO outputted from the backflow detecting comparator 13 becomes high level. Upon receipt of the high-level backflow detection signal REVO, the switch element control circuit 12 turns off the switch element Sw2 by setting the control signal NDRV to a low level. This control can prevent reduction in the power conversion efficiency of the switching regulator due to the backflow current. Moreover, during the time of backflow current prevention, an output current LOUT is supplied to the load 31 by the charges discharged from the output capacitor Cout. Thus, the slope of the voltage VOUT is equal to LOUT/Cout, and the voltage VOUT is linearly decreased with respect to time. Since, the slope of the voltage VOUT is dependent on IOUT as described above, the switching frequency can be changed according to the output current LOUT.

However, in a switching regulator shown in FIG. 1, when a ripple voltage width VFPP of a divided voltage VF is smaller than an input-referred offset voltage of a comparator 11 in a PWM control mode with operation at a high switching frequency, there may arise a problem that the comparator cannot accurately compare the divided voltage VF to the reference voltage VREF1. In order to show this in a quantitative way, the ripple voltage width VFPP of the divided voltage VF is expressed in mathematical form using an input voltage VCC, an output voltage VOUT, an output current LOUT, an inductance of an inductor L, an on-resistance Ron of switch elements Sw1 and Sw2, a switching frequency fsw, a series equivalent parasitic resistance Resr of an output capacitor Cout, and resistance values of resistors Rf1 and Rf2. The reference symbols of the inductor, capacitor and resistor below also represent the inductance, capacitance and resistance values thereof, respectively.

The ripple voltage width VFPP of the output voltage VOUT is expressed in the following equation:

VPP=dIL/dt×ton×Resr (1),

where IL represents an inductor current flowing through the inductor L and ton represents an on-time length of the switching regulator.

Note, however, that the ripple voltage width VFPP is a peak-to-peak value.

A time rate of change of the inductor current IL flowing through the inductor L during the on-cycle is given as the following equation:

dIL/dt=(VCC−VOUT−Ron×IOUT)/L (2),

where Ron represents an on-resistance of the switch elements Sw1 and Sw2

The on-time length ton of the switching regulator is expressed in the following equation:

ton=D×1/fsw (3),

where fsw represents a switching frequency and D represents a duty cycle.

Here, assuming for simplicity that parasitic resistances of both of the switch elements Sw1 and Sw2 are equal to Ron, the duty cycle D is obtained by the following equation:

D=(VOUT+Ron×IOUT)/VCC (4).

Substituting Equation (4) into Equation (3) gives the following equation:

ton=(VOUT+Ron×IOUT)NCC×1/fsw (5).

Substituting Equations (2) and (5) into Equation (1) gives the following equation:

VPP=(VCC−VOUT−IOUT×Ron)/L×(VOUT+Ron×IOUT)/VCC×1/fsw×Resr (6).

Since the output voltage VOUT is divided by the resistors Rf1 and Rf2, the ripple voltage width VFPP of the output voltage VOUT is also divided at a ratio of Rf2/(Rf1+Rf2) as in the case of the output voltage VOUT. Therefore, the ripple voltage width VFPP of the divided voltage VF is expressed in the following equation:

VFPP=VPP×Rf2/(Rfz1+Rf2) (7).

Note, however, that the ripple voltage width VFPP is a peak-to-peak value.

VFPP can be quantitatively calculated by substituting Equation (6) into Equation (7). For example, when VCC=10 V, VOUT=5 V, IOUT=10 A, L=1 μH, Ron=100 mΩ, fsw=10 MHz, Resr=1 mΩ, Rf1=3 MΩ, and Rf2=1 MΩ, VFPP=60 μV can be calculated from Equations (6) and (7). It is generally difficult to design a highly-accurate comparator 11 having an input-referred offset voltage of less than 60 μV. Thus, in this example, it is considered to be impossible to accurately compare the divided voltage VF with the reference voltage VREF1.

In order to solve such a problem, US Patent Application Publication No. 2010/0019749 (US-A201010019749) discloses a technique capable of amplifying the ripple voltage width VFPP of the divided voltage VF up to the level detectable by the comparator. In the invention disclosed in US-A2010/0019749, the ripple voltage width VFPP is amplified based on the voltage VLX at the node N1. For example, a voltage Vref_ci is generated by a circuit including a resistor Ri, a capacitor Ci, a current amplifier 171, a resistor R19 and a voltage source of a reference voltage Vref shown in FIG. 14 of US-A2010/0019749. As shown in FIG. 15 of US-A2010/0019749, the voltage Vref_ci is a voltage obtained by superimposing, as AC components, a ripple voltage width synchronized with on/off operations of a Pch transistor MH and an Nch transistor ML (FIG. 13 of US-A2010/0019749) on the reference voltage Vref. The ripple voltage width of the voltage Vref_ci can be controlled to have any voltage magnitude within a range from the ground voltage GND to the input voltage VCC by setting circuit constants of the resistor Ri and the capacitor Ci.

However, it is difficult to operate the switching regulator in the PFM control mode, which uses the means for amplifying the ripples based on the voltage VLX at the node N1. This is because the PFM control mode involves not only the two kinds of time, including the on-time when the switch element Sw1 is turned on and the switch element Sw2 is turned off and the off-time when the switch element Sw1 is turned off and the switch element Sw2 is turned on, as described above, but also a backflow prevention time when the switch elements Sw1 and Sw2 are simultaneously turned off to prevent a current from flowing back toward the switch element Sw2 from the output capacitor Cout under light load. The method for amplifying the ripples of the voltage VLX at the node N1 based on the on/off operations of the switch elements as disclosed in US-A2010/0019749 is only applicable to the two kinds of states, i.e., the on-time and the off-time. Particularly, the backflow prevention time is treated as a part of the off-time. Thus, although the generation of the backflow current can be prevented, it is difficult to change the switching frequency based on the level of the load in the same manner as the switching regulator shown in FIG. 9.

### SUMMARY

It is an object of the present invention to solve the foregoing problems and to provide a switching regulator capable of amplifying a ripple voltage width up to the level detectable by a comparator in a PWM control mode, and of changing a switching frequency according to the level of load in a PFM control mode.

In order to achieve the above object, an embodiment of the present invention provides a switching regulator configured to convert an input voltage into a predetermined output voltage using first and second switch elements series-connected between a voltage source of the input voltage and a terminal of a ground voltage, comprising: a ripple generating circuit configured to generate a ripple voltage signal having a voltage that increases when the first switch element is on and decreases when the second switch element is on, or a voltage that decreases when the first switch element is on and increases when the second switch element is on; a comparator configured to compare the ripple voltage signal to a first reference voltage, and generate a comparison signal indicating the comparison result; and a switch element control circuit configured to generate, according to the comparison signal, a first control signal to switch on and off of the first switch element and a second control signal to switch on and off of the second switch element, and apply the first and second control signals to the first and second switch elements, respectively, wherein the ripple generating circuit generates the ripple voltage signal based on the first and second control signals.

In order to achieve the above object, an embodiment of the present invention provides a switching regulator configured to convert an input voltage into a predetermined output voltage using first and second switch elements series-connected between a voltage source of the input voltage and a terminal of a ground voltage, comprising: a ripple generating circuit configured to generate a ripple voltage signal having a voltage that increases when the first switch element is on and decreases when the second switch element is on, or a voltage that decreases when the first switch element is on and increases when the second switch element is on; a comparator configured to compare the ripple voltage signal to a first reference voltage, and generate a comparison signal indicating the comparison result; and a switch element control circuit configured to generate, according to the comparison signal, a first control signal to switch on and off of the first switch element and a second control signal to switch on and off of the second switch element, and apply the first and second control signals to the first and second switch elements, respectively, wherein the ripple generating circuit generates the ripple voltage signal based on the first and second control signals, and the ripple generating circuit includes third and fourth switch elements series-connected between a voltage source of a second reference voltage and the terminal of the ground voltage, and an integrating circuit including a first resistor element and a first capacitor series-connected between the terminal of the ground voltage and a node between the third and fourth switch elements, the integrating circuit configured to generate an integrated voltage by integrating a voltage at the node, and on and off of the third and fourth switch elements are synchronized with on and off of the first and second switch elements, respectively.

In order to achieve the above object, an embodiment of the present invention provides a method of controlling a switching regulator configured to convert an input voltage into a predetermined output voltage using first and second switch elements series-connected between a voltage source of the input voltage and a terminal of a ground voltage, comprising the steps of: generating a ripple voltage signal having a voltage that increases when the first switch element is on and decreases when the second switch element is on, or a voltage that decreases when the first switch element is on and increases when the second switch element is on; comparing the ripple voltage signal to a first reference voltage, and generating a comparison signal indicating the comparison result; and generating, according to the comparison signal, a first control signal to switch on and off of the first switch element and a second control signal to switch on and off of the second switch element, and applying the first and second control signals to the first and second switch elements, respectively, wherein the step of generating the ripple voltage signal generates the ripple voltage signal based on the first and second control signals.

### BRIEF DESCRIPTION OF THE DRAWINGS

FIG. 1 is a circuit diagram showing a configuration of a switching regulator according to an embodiment of the present invention.

FIG. 2 is a circuit diagram showing an exemplary configuration of a ripple generating circuit 15 shown in FIG. 1.

FIG. 3 is a timing chart showing operations of the switching regulator shown in FIG. 1.

FIG. 4 is a circuit diagram showing an exemplary configuration of a mode signal generating circuit 14 shown in FIG. 1.

FIG. 5 is a timing chart showing an operation of the switching regulator shown in FIG. 1 switching from a PFM control mode to a PWM control mode.

FIG. 6 is a circuit diagram showing an exemplary configuration of a ripple generating circuit 15A according to a first modified example of the embodiment of the present invention.

FIG. 7 is a circuit diagram showing an exemplary configuration of a ripple generating circuit 15B according to a second modified example of the embodiment of the present invention.

FIG. 8 is a circuit diagram showing an exemplary configuration of a ripple generating circuit 15C according to a third modified example of the embodiment of the present invention.

FIG. 9 is a circuit diagram showing a configuration of a switching regulator according to a conventional example.

FIG. 10 is a timing chart showing an operation of the switching regulator shown in FIG. 9 detecting a backflow.

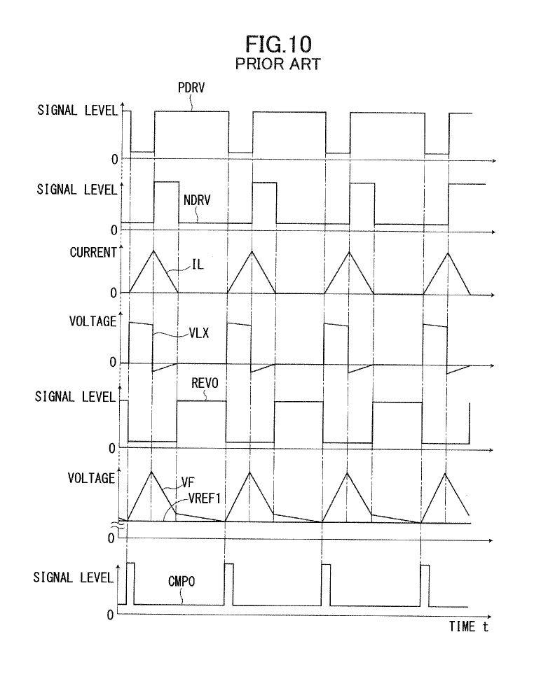

### DETAILED DESCRIPTION OF THE PREFERRED EMBODIMENTS

With reference to the drawings, a switching regulator according to an embodiment of the present invention is described below. Note that, in the following embodiment, the same constituent components are denoted by the same reference numerals.

To achieve the foregoing object, the present invention has the following configuration.

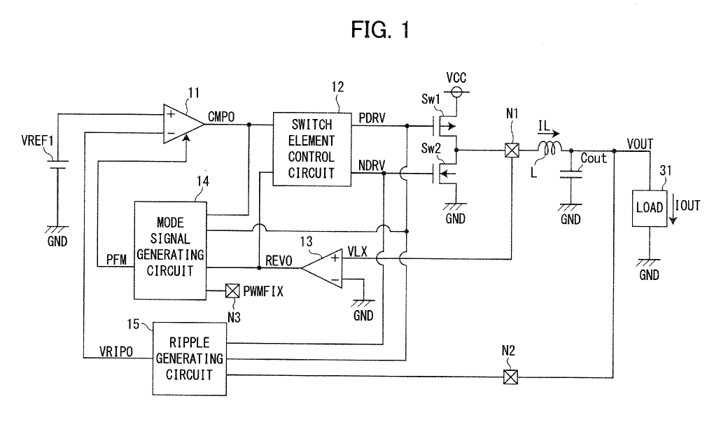

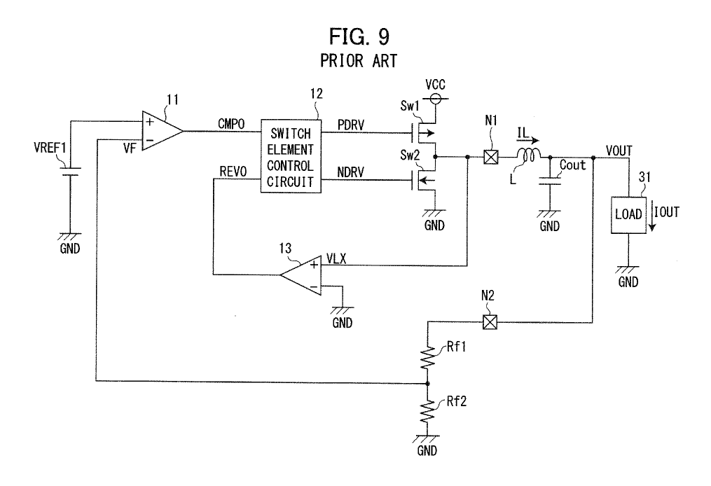

FIG. 1 is a circuit diagram showing a configuration of a switching regulator according to an embodiment of the present invention. The switching regulator shown in FIG. 1 includes a mode signal generating circuit 14 and a ripple generating circuit 15 in addition to the configuration of the switching regulator according to the conventional example shown in FIG. 9. An output voltage VOUT and control signals PDRV and NDRV, which are outputted from a switch element control circuit 12, are inputted to the ripple generating circuit 15. Based on the inputted output voltage and control signals, the ripple generating circuit 15 generates a ripple voltage signal VRIPO having a ripple voltage width that is substantially amplified compared to a ripple voltage width of the output voltage VOUT. The ripple voltage signal VRIPO outputted from the ripple generating circuit 15 is inputted to an inverting input terminal of a comparator 11. Meanwhile, a comparison signal CMPO outputted from the comparator 11, a backflow detection signal REVO outputted from a backflow detecting comparator 13, a control signal PDRV of a switch element Sw1, and a PWM fixing signal PWMFIX (an input signal at a node N3) are inputted to the mode signal generating circuit 14. Based on these inputted signals, the mode signal generating circuit 14 generates a mode signal PFM indicating either a PFM control mode or a PWM control mode. The mode signal generating circuit 14 always generates a mode signal PFM indicating the PWM control mode when the PWM fixing signal PWMFIX is at a high level (PWM fixing control). On the other hand, when the PWM fixing signal PWMFIX is at a low level, the mode signal generating circuit 14 generates the mode signal indicating either the PFM control mode or the PWM control mode according to the backflow detection signal and the comparison signal (automatic control). The mode signal PFM outputted from the mode signal generating circuit 14 is inputted to the comparator 11. The switching regulator shown in FIG. 1 is characterized by having the configuration described above. The other configuration thereof is the same as that of the switching regulator shown in FIG. 9, and thus detailed description thereof is omitted.

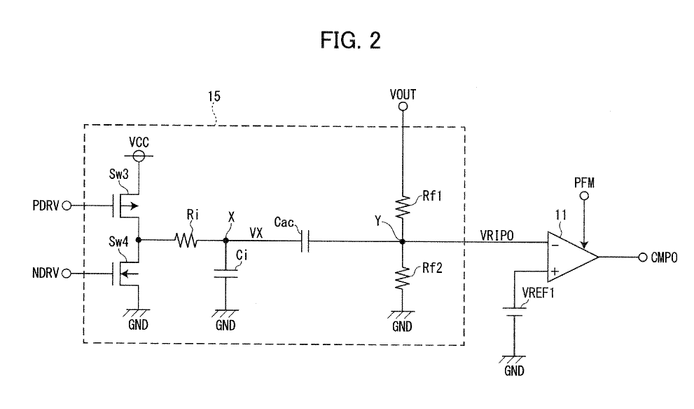

FIG. 2 is a circuit diagram showing an exemplary configuration of a ripple generating circuit 15 shown in FIG. 1. In FIG. 2, the ripple generating circuit 15 includes switch elements Sw3 (third switch element) and Sw4 (fourth switch element) resistors Ri (first resistor element), Rf1 (second resistor element), and Rf2 (third resistor element) and capacitors Ci (first capacitor) and Cac (second capacitor). The switch element Sw3 is a Pch transistor, which is the same as the switch element Sw1, and the switch element Sw4 is an Nch transistor, which is the same as the switch element Sw2. The switch elements Sw3 and Sw4 are series-connected between a voltage source of an input voltage VCC and a terminal of a ground voltage GND. The control signals PDRV and NDRV outputted from the switch element control circuit 12 are applied to gates of the switch elements Sw3 and Sw4, respectively. Therefore, on and off of the switch elements Sw3 and Sw4 are synchronized with on and off of the switch elements Sw1 and Sw2, respectively. The resistor Ri and the capacitor Ci are series-connected between a terminal of the ground voltage GND and a node between the switch elements Sw3 and Sw4, thus forming an integrating circuit configured to generate an integrated voltage by integrating a voltage at the node between the switch elements Sw3 and Sw4.

When the control signals PDRV and NDRV are both at a low level, the switch element Sw3 is turned on and the switch element Sw4 is turned off. In this event, the voltage source of the input voltage VCC is connected to the resistor Ri and the capacitor Ci to charge the capacitor Ci. Thus, a voltage VX at a node X between the resistor Ri and the capacitor Ci is increased. On the other hand, when the control signals PDRV and NDRV are both at a high level, the switch element Sw3 is turned off and the switch element Sw4 is turned on. In this event, the terminal of the ground voltage GND is connected to the resistor Ri and the capacitor Ci to discharge the capacitor Ci. Thus, the voltage VX at the node X is decreased. Meanwhile, when the control signal PDRV is at the high level and the control signal NDRV is at the low level, the switch elements Sw3 and Sw4 are simultaneously turned off. In this event, charges in the capacitor Ci are kept constant instead of being stored or discharged. Thus, the voltage VX at the node X takes a constant value. In this way, the ripple generating circuit 15 generates the voltage VX having ripple components.

In the ripple generating circuit 15, the resistors Rf1 and Rf2 are series-connected between a terminal (a node N2) of the output voltage VOUT and a terminal of the ground voltage GND, while the capacitor Cac is connected to the node X and a node Y between the resistors Rf1 and Rf2. DC components of the voltage VX at the node X are cut off by the capacitor Cac, and only AC components of the voltage VX are transmitted to the node Y Moreover, a voltage obtained by dividing the output voltage VOUT by the resistors Rf1 and Rf2 is generated at the node Y. At the node Y, the AC components of the voltage VX are superimposed on the voltage obtained by dividing the output voltage VOUT, thereby generating the ripple voltage signal VRIPO having ripple components. In this way, the ripple generating circuit 15 generates the ripple voltage signal VRIPO by superimposing the integrated voltage on the voltage (divided voltage) proportional to the output voltage VOUT.

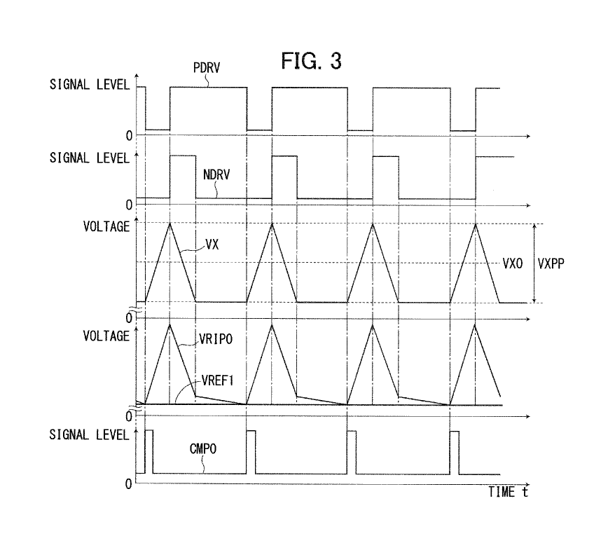

FIG. 3 is a timing chart showing operations of the switching regulator shown in FIG. 1. The timing chart shown in FIG. 3 shows time-variable waveforms of the control signals PDRV and NDRV, the voltage VX at the node X, the ripple voltage signal VRIPO and the comparison signal CMPO. The ripple voltage signal VRIPO has a voltage that increases in proportion to the time when the control signal PDRV is at a high level (when the switch element Sw1 is on), and decreases in proportion to the time when the control signal NDRV is at a high level (when the switch element Sw2 is on).

A quantitative discussion is given below, based on mathematical expressions, concerning the principles of generation of the ripple voltage signal VRIPO having ripple components at a detectable level by the comparator 11 by use of the ripple generating circuit 15. For simplification, it is assumed in the following discussion that a capacitance of the capacitor Ci is sufficiently larger than that of the capacitor Cac.

The voltage VX at the node X is represented by VX (t) as a function of time t. First, the voltage VX (t) is formulated in terms of on-time, off-time and backflow prevention time, respectively. As described above, the on-time is a period when the switch element Sw1 is on and the switch element Sw2 is off (i.e., a period when the control signals PDRV and NDRV are simultaneously at a low level). The off-time is a period when the switch element Sw1 is off and the switch element Sw2 is on (i.e., a period when the control signals PDRV and NDRV are simultaneously at a high level). The backflow prevention time is a period when the switch elements Sw1 and Sw2 are simultaneously off (i.e., a period when the control signal PDRV is at the high level and the control signal NDRV is at the low level).

Charges Qchg and Qdchg are expressed in the following equations, respectively:

$$\begin{matrix}[ Equation 1 ] & \\ Qchg = {\int }_{0}^{to n} \frac{VCC - VX ( t )}{Ri} d t , and & ( 8 ) \\ [ Equation 2 ] & \\ Qdchg = {\int }_{0}^{toff} \frac{VX ( t )}{Ri} d t , & ( 9 )\end{matrix}$$

where ton represents the length of the on-time, Qchg represents charges stored in the capacitor Ci, toff represents the length of the off-time, and Qdchg represents charges discharged from the capacitor Ci.

Assuming for simplicity that the AC components of VX (t) are sufficiently smaller than the DC components after the elapse of sufficient time Te>>Ri×Ci following repetitive on and off of the switch elements Sw3 and Sw4, the voltage VX (t) can be approximated by its average value VX0 in Equations (8) and (9). Therefore, Equations (8) and (9) are expressed as follows, respectively:

Qchg=ton×(VCC−VX0)/Ri (10), and

Qdchg=toff×VX0/Ri (11).

When a ratio of the length ton of the on-time to the length toff of the off-time is constant, Qchg=Qdchg. Thus, the average value VX0 of the voltage VX (t) at the node X is expressed in the following equation:

VX0=ton/(ton+toff)×VCC (12).

Here, since ton/(ton+toff) is equal to a duty cycle D in the switching regulator shown in FIG. 1, the following equation holds:

VX0=D×VCC (13).

The duty cycle D is the same as that in the case of the switching regulator according to the conventional example shown in FIG. 9. Therefore, substituting Equation (4) into Equation (13) gives the following equation:

VX0=VOUT+Ron×IOUT (14).

A time rate of change dQchg/dt of the charges Qchg stored in the capacitor Ci during the on-time is expressed as follows from Equation (8):

dQchg/dt=Ci×dVX/dt=(VCC−VX(t))/Ri (15).

For simplicity, approximating VX (t) and VX0 in Equation (15) gives the following equation:

dVX/dt=(VCC−VX0)/(Ri×Ci) (16).

Substituting Equation (14) into Equation (16) gives the following equation:

dVX/dt=(VCC−VOUT−Ron×IOUT)/(Ri×Ci) (17).

A time rate of change dQdchg/dt of the charges Qdchg discharged from the capacitor Ci during the off-time is expressed as follows from Equation (9):

dQdchg/dt=Ci×dVX/dt=−VX(t)/Ri (18).

Approximating VX (t) and VX0 in Equation (18) gives the following equation:

dVX/dt=−VX0/(Ri×Ci) (19).

Substituting Equation (14) into Equation (19) gives the following equation:

dVX/dt=−(VOUT+Ron×IOUT)/(Ri×Ci) (20).

Meanwhile, since the charges in the capacitor Ci are kept constant, during the backflow prevention time, instead of being stored or discharged, dVX/dt=0.

Based on the values of dVX/dt calculated for the on-time, the off-time and the backflow prevention time, respectively, the time-variable waveform of the voltage VX at the node X can be expressed as shown in FIG. 3.

Since the ripple voltage width VXPP of the voltage VX at the node X is equal to the product of the time rate of change dVX/dt of the voltage VX at the node X during the on-time and the length ton of the on-time (or the product of the time rate of change dVX/dt of the voltage VX at the node X during the off-time and the length toff of the off-time), the following equation holds:

VXPP=dVX/dt×ton (21).

For simplicity, the ripple voltage width VXPP in the case of no backflow prevention time is considered. In this event, since the length ton of the on-time is represented by exactly the same equation as Equation (5), substituting Equations (5) and (17) into Equation (21) gives the following equation:

VXPP=(VCC−VOUT−Ron×IOUT)/(Ri×Ci)×(VOUT+Ron×IOUT)/VCC×1/fsw (22).

Furthermore, the ripple voltage width VXPP of the voltage VX at the node X is expressed as follows using the ripple voltage width VPP of the output voltage VOUT from Equations (6) and (22):

VXPP=1/(Ri×Ci)×L/Resr×VPP (23).

Since the AC components of the voltage VX at the node X are transmitted to the node Y through the capacitor Cac, the ripple voltage width of the ripple voltage signal VRIPO is obtained by adding the ripple voltage width of the voltage obtained by dividing the output voltage VOUT of the switching regulator by the resistors Rf1 and Rf2 to the ripple voltage width VXPP of the voltage VX. Therefore, by determining the values of the resistor Ri and the capacitor Ci so as to satisfy Ri×Ci<<L/Resr, the ripple voltage signal VRIPO can be amplified by an arbitrary multiplication factor with respect to the ripple voltage width VPP of the output voltage VOUT, within the range from the ground voltage GND to the input voltage VCC. For example, when inductance of an inductor L is 1 μH and series equivalent parasitic resistance Resr of an output capacitor Cout is 1 mΩ, the ripple voltage width VXPP of the voltage VX at the node X is 1000 times the ripple voltage width VPP of the output voltage VOUT if the resistance value of the resistor Ri is 1 MΩ and the capacitance of the capacitor Ci is 1 pF. Thus, the ripple voltage width of the ripple voltage signal VRIPO can be significantly amplified compared to the ripple voltage width VPP of the output voltage VOUT.

Therefore, even in the PWM control mode operated at a high switching frequency, the ripple voltage width of the ripple voltage signal VRIPO can be adjusted to the level detectable by the comparator 11.

Note that, in order to turn on or off the switch element Sw4, the logical product of the control signal PDRV of the switch element Sw1 and the inversion signal of the backflow detection signal REVO may be used instead of the control signal NDRV of the switch element Sw2. In this case, the switching regulator operates in the same way as the case of using the control signal NDRV.

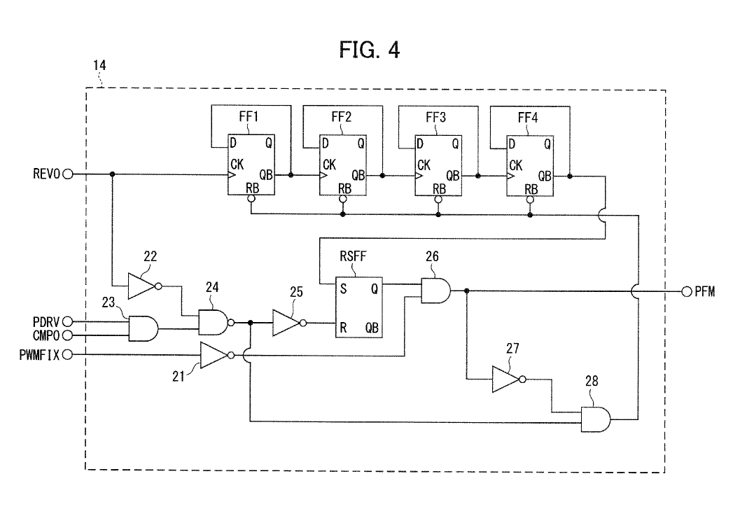

FIG. 4 is a circuit diagram showing an exemplary configuration of the mode signal generating circuit 14 shown in FIG. 1. In FIG. 4, the mode signal generating circuit 14 includes D flip-flop circuits FF1, FF2, FF3 and FF4, an RS flip-flop circuit RSFF, inverter circuits 21, 22, 25 and 27, AND circuits 23, 26 and 28, and an NAND circuit 24.

The D flip-flop circuits FF1 to FF4 constitute an octal counter. A backflow detection signal REVO is inputted to a clock input terminal CK of the D flip-flop circuit FF1. An inverted output signal QB of the D flip-flop circuit FF1 is inputted to a D-input terminal D of the D flip-flop circuit FF1. The inverted output signal QB of the D flip-flop circuit FF1 is inputted to a clock input terminal CK of the D flip-flop circuit FF2. An inverted output signal QB of the D flip-flop circuit FF3 is inputted to a D-input terminal D of the D flip-flop circuit FF3. An inverted output signal QB of the D flip-flop circuit FF2 is inputted to a clock input terminal CK of the D flip-flop circuit FF3. An inverted output signal QB of the D flip-flop circuit FF4 is inputted to a D-input terminal D of the D flip-flop circuit FF4. The inverted output signal QB of the D flip-flop circuit FF3 is inputted to a clock input terminal CK of the D flip-flop circuit FF4. An output signal of the AND circuit 28 is inputted to a reset bar input terminal RB of each of the D flip-flop circuits FF1 to FF4.

The control signal PDRV of the switch element Sw1 is inputted to a first input terminal of the AND circuit 23. The comparison signal CMPO is inputted to a second input terminal of the AND circuit 23. A signal obtained by inverting the backflow detection signal REVO by the inverter circuit 22 is inputted to a first input terminal of the NAND circuit 24. An output signal of the AND circuit 23 is inputted to a second input terminal of the NAND circuit 24. The inverted output signal QB of the D flip-flop circuit FF4 is inputted to a set input terminal S of the RS flip-flop circuit RSFF. A signal obtained by inverting an output signal of the NAND circuit 24 by the inverter circuit 25 is inputted to a reset input terminal R of the RS flip-flop circuit RSFF. A non-inverted output signal Q of the RS flip-flop circuit RSFF is inputted to a first input terminal of the AND circuit 26. A signal obtained by inverting the PWM mode fixing signal PWMFIX by the inverter circuit 21 is inputted to a second input terminal of the AND circuit 26. An output signal of the AND circuit 26 is outputted from the mode signal generating circuit 14 as a mode signal PFM. The mode signal PFM is inverted by the inverter circuit 27 and inputted to a first input terminal of the AND circuit 28. The output signal of the NAND circuit 24 is inputted to a second input terminal of the AND circuit 28.

Next, operations of the mode signal generating circuit 14 shown in FIG. 4 are described.

When the PWM mode fixing signal PWMFIX is at a high level, a low-level signal is inputted to the second input terminal of the AND circuit 26. Thus, regardless of the logic levels of the backflow detection signal REVO and the comparison signal CMPO, the mode signal PFM becomes low level.

When the PWM fixing signal PWMFIX is at a low level, the RS flip-flop circuit RSFF is reset and the non-inverted output signal Q thereof becomes low level if an output signal of the inverter 25 becomes high level. Thus, the mode signal PFM becomes low level. On the other hand, if the output signal of the inverter 25 becomes low level, the RS flip-flop circuit RSFF is not reset and the non-inverted output signal Q thereof becomes equal to the logic level of the set input terminal S. Since the high-level signal is inputted to the second input terminal of the AND circuit 26, the logic level of the mode signal PFM becomes equal to the logic level of the non-inverted output signal Q of the RS flip-flop. In the octal counter including the D flip-flop circuits FF1 to FF4, if the rising edge of the backflow detection signal REVO is inputted eight times to the clock input terminal CK of the D flip-flop circuit FF1, the inverted output signal QB of the D flip-flop circuit FF4 becomes high level. In the RS flip-flop circuit RSFF, when the high-level signal is inputted to the set input terminal S, the non-inverted output signal Q becomes high level, and thus the mode signal PFM becomes high level. The high-level mode signal PFM is inverted by the inverter circuit 27, and the low-level signal is inputted to the first input terminal of the AND circuit 28. Thus, the output signal of the AND circuit 28 becomes low level, and all the D flip-flop circuits FF1 to FF4 are reset.

The switching regulator shown in FIG. 1 always performs the PWM fixing control operating in the PWM control mode when the PWM fixing signal PWMFIX is at the high level, and performs the automatic control to automatically switch between the PFM control mode and the PWM control mode when the PWM fixing signal PWMFIX is at the low level. In the automatic control, the PFM control mode and the PWM control mode are automatically switched therebetween according to the magnitude of an output current IOUT (actually, according to the backflow detection signal REVO), thereby switching the logic level of the mode signal PFM. The switching regulator operates in the PFM control mode when the mode signal PFM is at the high level, and operates in the PWM control mode when the mode signal PFM is at the low level.

As described above, the mode signal PFM is inputted to the comparator 11. The comparator 11 switches the magnitude of the consumption current of the comparator 11 according to the logic level of the mode signal PFM. Generally, the larger the consumption current, the shorter the delay time of detection by the comparator. Thus, the speed of the comparator tends to be increased. In the PFM control mode, the switching frequency of the switching regulator is small, and thus the comparator 11 is not required to be speeded up. On the other hand, in the PWM control mode, the switching frequency of the switching regulator is increased, and the comparator 11 is required to operate at high speed. Therefore, control is performed such that the consumption current of the comparator 11 is reduced when the mode signal PFM is at the high level, and the consumption current of the comparator 11 is increased when the mode signal PFM is at the low level. Accordingly, the consumption current of the switching regulator in the PFM control mode can be reduced, thus achieving an effect of improving the power conversion efficiency of the switching regulator under light load.

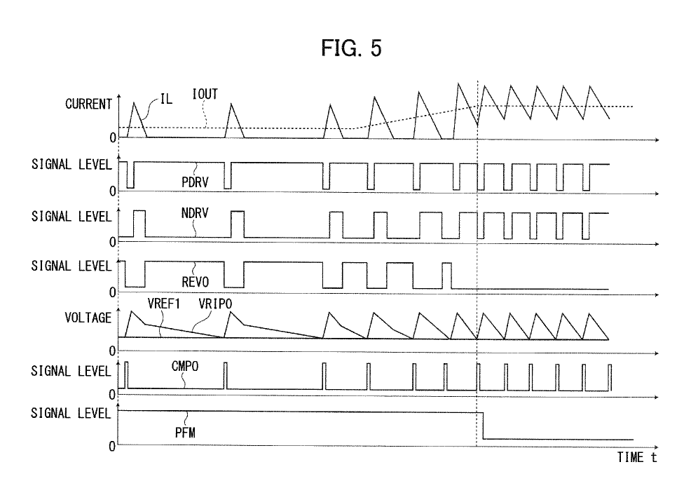

FIG. 5 is a timing chart showing an operation of the switching regulator shown in FIG. 1 switching from the PFM control mode to the PWM control mode. The timing chart shown in FIG. 5 illustrates waveforms of respective signals until the switching regulator is switched from the PFM control mode to the PWM control mode when the output current IOUT of the switching regulator is gradually increased from a light load state to a heavy load state in the case where the PWM mode fixing signal PWMFIX is at the low level (i.e., in the case of the automatic control).

With reference to the timing chart shown in FIG. 5, operations of the switching regulator shown in FIG. 1 are described below.

In FIG. 1, when the backflow detecting comparator 13 detects a backflow current during the light load state, the backflow detection signal REVO becomes high level and the control signal NDRV of the switch element Sw2 becomes low level, thereby turning off the switch element Sw2. This operation prevents the backflow current from flowing into the ground voltage GND through the switch element Sw2. When the ripple voltage signal VRIPO is reduced from a state higher than the reference voltage VREF1 and becomes equal to the reference voltage VREF1, the comparison signal CMPO is changed from the low level to the high level. In this event, the control signal PDRV of the switch element Sw1 is changed from the high level to the low level, and an inductor current IL starts to be increased. As a result, the backflow detection signal REVO is changed from the high level to the low level. When the control signal PDRV of the switch element Sw1 is at the low level, the ripple voltage signal VRIPO is increased to be larger than the reference voltage VREF1. Thus, the comparison signal CMPO is changed from the high level to the low level.

Therefore, the comparison signal CMPO and the control signal PDRV of the switch element Sw1 do not become high level at the same time as when the backflow detection signal REVO becomes low level. Thus, a low-level signal is always inputted to the reset input terminal R of the RS flip-flop circuit RSFF. In this way, while the RS flip-flop circuit RSFF is not reset, the operation of the backflow detecting comparator 13 detecting the backflow current is repeated. Thus, the backflow detection signal REVO repeats transition between the high level and the low level (i.e., the rising edge of the backflow detection signal REVO is repeatedly inputted to the mode signal generating circuit 14). Accordingly, the mode signal PFM keeps holding the high level. Therefore, the switching regulator operates in the PFM control mode.

As shown in FIG. 5, as the output current IOUT is gradually increased from the light load state to the heavy load state, the backflow detecting comparator 13 comes to no longer detect the backflow current at some point. The backflow detection signal REVO is maintained at the low level unless the backflow current is detected. In this event, when the ripple voltage signal VRIPO is reduced and becomes equal to the reference voltage VREF1, the comparison signal CMPO shifts from low level to high level. Next, the switch element control circuit 12 changes the control signals PDRV and NDRV from high level to low level, and switches from an on-cycle of the switch element Sw2 to an on-cycle of the switch element Sw1. In this process, there is time when the comparison signal CMPO and the control signal PDRV simultaneously become high level. At this time, the output signal of the AND circuit 23 becomes high level. When the backflow detection signal REVO is at the low level and the output signal of the AND circuit 23 is at the high level, the NAND circuit 24 outputs a low-level signal and then the inverter circuit 25 inputs a high-level signal to the reset input terminal R of the RS flip-flop circuit. When the high-level signal is inputted to the reset input terminal R, the non-inverted output signal Q of the RS flip-flop circuit becomes low level. Thus, the mode signal PFM to be outputted from the AND circuit 26 becomes low level, and the control mode is switched from the PFM control mode to the PWM control mode.

On the other hand, when switching from the PWM control mode to the PFM control mode, the switching regulator operates as follows. As the output current IOUT is gradually decreased from the heavy load state to the light load state, the backflow detecting comparator 13 starts to detect the backflow current, and the backflow detection signal REVO becomes high level. When the octal counter including the D flip-flop circuits FF1 to FF4 counts the rising edge of the backflow detection signal REVO eight times, the inverted output signal QB of the D flip-flop circuit FF4 becomes high level. This high-level inverted output signal QB is inputted to the set input terminal S of the RS flip-flop circuit RSFF. When the backflow detection signal REVO repeats transition between the high level and the low level, the control signal PDRV of the switch element Sw1 and the comparison signal CMPO do not become high level at the same time as when the backflow detection signal REVO is at the low level as described above. Thus, the low-level signal is always inputted to the reset input terminal R of the RS flip-flop circuit RSFF. In this event, the non-inverted output signal Q of the RS flip-flop circuit RSFF is at the high level, and the mode signal PFM to be outputted from the AND circuit 26 becomes high level. Thus, the switching regulator is switched from the PWM control mode to the PFM control mode.

In this way, in the automatic control, the PFM control mode and the PWM control mode are automatically switched therebetween according to the magnitude of the output current IOUT of the switching regulator. The reason why the rising edge of the backflow detection signal REVO is counted eight times by the octal counter including the D flip-flop circuits FF1 to FF4 is to prevent a chattering phenomenon involving repetitive operations of switching back to the PFM control mode immediately after switching from the PFM control mode to the PWM control mode around the switching current, and then setting again the PWM control mode. Note that the number of counts is set to 8 in the embodiment described above, but does not always have to be 8. The same effect is achieved with any number of counts.

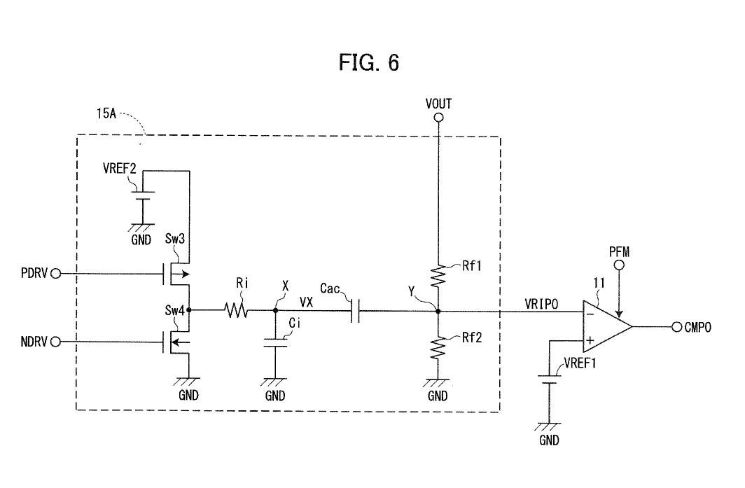

FIG. 6 is a circuit diagram showing an exemplary configuration of a ripple generating circuit 15A according to a first modified example of the embodiment of the present invention. As shown in FIG. 6, the same effect as that achieved with the ripple generating circuit 15 shown in FIG. 2 can be achieved even when the switch element Sw3 is connected to a voltage source of a certain reference voltage VREF2 instead of being connected to the voltage source of the input voltage VCC.

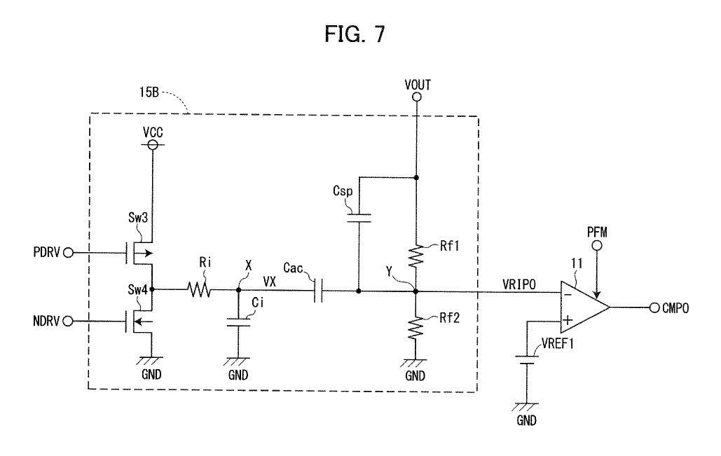

FIG. 7 is a circuit diagram showing an exemplary configuration of a ripple generating circuit 15B according to a second modified example of the embodiment of the present invention. The ripple generating circuit 15B shown in FIG. 7 includes a capacitor Csp (third capacitor) in parallel with the resistor Rf1 between a terminal of the output voltage VOUT and the node Y, in addition to the configuration of the ripple generating circuit 15 shown in FIG. 2.

In the ripple generating circuit 15 shown in FIG. 2, when a steep change occurs in the output current IOUT of the switching regulator, the ripple voltage signal VRIPO may be significantly changed or the variation in the output voltage VOUT may be increased accordingly. The use of the ripple generating circuit 15B shown in FIG. 7 has an effect of reducing such variations. For example, a case of a steep increase in the output current IOUT is considered. In this event, when charges are extracted from the output capacitor Cout, the output voltage VOUT undergoes significant undershoot. Thus, the switching regulator supplies more currents from the input voltage VCC by temporarily drastically increasing the duty cycle D, thereby compensating for the decline in the output voltage VOUT to keep the output voltage constant. However, as can be seen from Equation (13), the voltage VX of the node X of the ripple generating circuit 15 shown in FIG. 2 is significantly increased with a drastic increase in the duty cycle D. Accordingly, such a change is transmitted to the node Y through the capacitor Cac and thus the ripple voltage signal VRIPO is drastically increased. As a result, a difference between the ripple voltage signal VRIPO and the reference voltage VREF1 is increased. For this reason, it takes longer for the comparison signal CMPO to become high level. Moreover, the switching frequency of the switching regulator is significantly reduced, and the current supply from the input voltage VCC to the output capacitor Cout is reduced. As a result, the undershoot amount of the output voltage VOUT is increased. To counter this problem, the ripple generating circuit 15 shown in FIG. 7 has an effect of reducing the drastic increase in the ripple voltage signal VRIPO by quickly transmitting the variation in the output voltage VOUT caused by the undershoot from the terminal of the output voltage VOUT to the node Y through the capacitor Csp, and thus preventing an increase in the undershoot amount due to a drastic decrease in the output voltage VOUT. Moreover, the ripple generating circuit 15 can similarly reduce an increase in overshoot occurring when the output current IOUT of the switching regulator undergoes a steep decline.

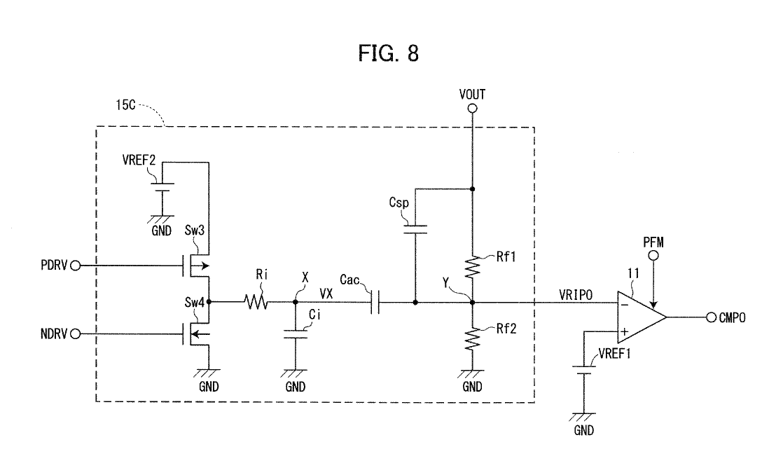

FIG. 8 is a circuit diagram showing an exemplary configuration of a ripple generating circuit 15C according to a third modified example of the embodiment of the present invention. The ripple generating circuit 15C shown in FIG. 8 has a configuration combining the reference voltage VREF2 shown in FIG. 6 and the capacitor Csp shown in FIG. 7. As shown in FIG. 8, the switch element Sw3 is connected to a voltage source of a certain reference voltage VREF2 instead of being connected to the voltage source of the input voltage VCC. Moreover, the capacitor Csp is connected in parallel with the resistor Rf1. Thus, the same effect as those achieved in the other examples described above can be achieved. Furthermore, as in the case of the modified example shown in FIG. 7, the ripple generating circuit 15C achieves an effect of reducing a large fluctuation that can occur in the ripple voltage signal VRIPO due to a steep change in the output current IOUT and the like.

While the mode signal generating circuit 14 counts the rising edge of the backflow detection signal REVO in the above description, the mode signal generating circuit 14 may count a falling edge of the backflow detection signal REVO instead.

Moreover, in the above description, the mode signal PFM is inputted to the comparator 11 and used to control the consumption current of the comparator 11. However, the same effect can also be achieved by controlling the consumption current of the other circuits (e.g., the switch element control circuit 12 and the like) included in the switching regulator, besides the comparator 11.

Furthermore, in the above description, the ripple voltage signal VRIPO has the voltage that increases when the switch element Sw1 is on and decreases when the switch element Sw2 is on. However, the ripple voltage signal VRIPO may have other waveforms. In this case, the input polarity of the comparator 11 is inverted and the comparison signal CMPO to be outputted from the comparator 11 becomes high level, the switch element control circuit 12 is controlled to set both of the control signals PDRV and NDRV at the high level to turn off the switch element Sw1 and turn on the switch element Sw2. Thus, the ripple voltage signal VRIPO has the voltage that decreases when the switch element Sw1 is on and increases when the switch element Sw2 is on. Such a switching regulator can achieve the same effect as that achieved in the embodiment.

The switching regulator according to the embodiment described above can amplify the ripple voltage width up to the level detectable by the comparator 11 in the PWM control mode and can change the switching frequency according to the level of the load 31 in the PFM control mode by generating the ripple voltage signal VRIPO based on the control signals PDRV and NDRV outputted from the switch element control circuit 12.

In the switching regulator according to an embodiment of the present invention, the ripple voltage signal is generated based on the two control signals outputted from the switch element control circuit. Thus, the switching regulator can amplify a ripple voltage width up to the level detectable by the comparator in a PWM control mode, and can also change a switching frequency according to the level of load in a PFM control mode.

A switching regulator configured to convert an input voltage into a predetermined output voltage using first and second switch elements series-connected between a voltage source of the input voltage and a terminal of a ground voltage, includes: a ripple generating circuit configured to generate a ripple voltage signal having a voltage that increases when the first switch element is on and decreases when the second switch element is on, or a voltage that decreases when the first switch element is on and increases when the second switch element is on; a comparator configured to compare the ripple voltage signal to a first reference voltage, and generate a comparison signal indicating the comparison result; and a switch element control circuit configured to generate, according to the comparison signal, a first control signal to switch on and off of the first switch element and a second control signal to switch on and off of the second switch element, and apply the first and second control signals to the first and second switch elements, respectively, wherein the ripple generating circuit generates the ripple voltage signal based on the first and second control signals.

The ripple generating circuit includes third and fourth switch elements series-connected between the voltage source of the input voltage and the terminal of the ground voltage, and an integrating circuit including a first resistor element and a first capacitor series-connected between the terminal of the ground voltage and a node between the third and fourth switch elements, the integrating circuit configured to generate an integrated voltage by integrating a voltage at the node, and on and off of the third and fourth switch elements are synchronized with on and off of the first and second switch elements, respectively.

The ripple generating circuit generates the ripple voltage signal by superimposing the integrated voltage on the voltage proportional to the output voltage.

The ripple generating circuit includes second and third resistor elements series-connected between a terminal of the output voltage and the terminal of the ground voltage, and a second capacitor connected to a node between the first resistor element and the first capacitor and to a node between the second and third resistor elements, and the ripple generating circuit generates the ripple voltage signal at the node between the second and third resistor elements by superimposing the integrated voltage through the second capacitor on the output voltage divided at the node between the second and third resistor elements.

The ripple generating circuit includes a third capacitor in parallel with the second resistor element between the terminal of the output voltage and the node between the second and third resistor elements.

The switching regulator further includes: a backflow detection circuit configured to generate a backflow detection signal indicating whether or not a backflow current is generated, which flows from a node between the first and second switch elements to the second switch element; and a mode signal generating circuit configured to generate a mode signal indicating any of a PFM (Pulse Frequency Modulation) control mode and a PWM (Pulse Width Modulation) control mode according to the backflow detection signal and the comparison signal, wherein consumption current of the circuits included in the switching regulator is controlled based on the mode signal.

The mode signal generating circuit includes a counter circuit configured to count rising edges or falling edges of the backflow detection signal, and the mode signal generating circuit generates a mode signal indicating the PFM control mode when the counter circuit counts a predetermined number of rising edges or falling edges of the backflow detection signal.

The mode signal generating circuit generates a mode signal indicating the PWM control mode at a predetermined point in time determined by the comparison signal and the first control signal when the backflow detection signal is at a low level.

The mode signal generating circuit has an input signal to select any of PWM fixing control to always generate a mode signal indicating the PWM control mode and automatic control to generate the mode signal indicating either the PFM control mode or the PWM control mode according to the backflow detection signal and the comparison signal.

A switching regulator configured to convert an input voltage into a predetermined output voltage using first and second switch elements series-connected between a voltage source of the input voltage and a terminal of a ground voltage, includes: a ripple generating circuit configured to generate a ripple voltage signal having a voltage that increases when the first switch element is on and decreases when the second switch element is on, or a voltage that decreases when the first switch element is on and increases when the second switch element is on; a comparator configured to compare the ripple voltage signal to a first reference voltage, and generate a comparison signal indicating the comparison result; and a switch element control circuit configured to generate, according to the comparison signal, a first control signal to switch on and off of the first switch element and a second control signal to switch on and off of the second switch element, and apply the first and second control signals to the first and second switch elements, respectively, wherein the ripple generating circuit generates the ripple voltage signal based on the first and second control signals, and the ripple generating circuit includes third and fourth switch elements series-connected between a voltage source of a second reference voltage and the terminal of the ground voltage, and an integrating circuit including a first resistor element and a first capacitor series-connected between the terminal of the ground voltage and a node between the third and fourth switch elements, the integrating circuit configured to generate an integrated voltage by integrating a voltage at the node, and on and off of the third and fourth switch elements are synchronized with on and off of the first and second switch elements, respectively.

The ripple generating circuit generates the ripple voltage signal by superimposing the integrated voltage on the voltage proportional to the output voltage.

The ripple generating circuit includes second and third resistor elements series-connected between a terminal of the output voltage and the terminal of the ground voltage, and a second capacitor connected to a node between the first resistor element and the first capacitor and to a node between the second and third resistor elements, and the ripple generating circuit generates the ripple voltage signal at the node between the second and third resistor elements by superimposing the integrated voltage through the second capacitor on the output voltage divided at the node between the second and third resistor elements.

The ripple generating circuit includes a third capacitor in parallel with the second resistor element between the terminal of the output voltage and the node between the second and third resistor elements.

The switching regulator, further includes: a backflow detection circuit configured to generate a backflow detection signal indicating whether or not a backflow current is generated, which flows from a node between the first and second switch elements to the second switch element; and a mode signal generating circuit configured to generate a mode signal indicating any of a PFM (Pulse Frequency Modulation) control mode and a PWM (Pulse Width Modulation) control mode according to the backflow detection signal and the comparison signal, wherein consumption current of the circuits included in the switching regulator is controlled based on the mode signal.

The mode signal generating circuit includes a counter circuit configured to count rising edges or falling edges of the backflow detection signal, and the mode signal generating circuit generates a mode signal indicating the PFM control mode when the counter circuit counts a predetermined number of rising edges or falling edges of the backflow detection signal.

The mode signal generating circuit generates a mode signal indicating the PWM control mode at a predetermined point in time determined by the comparison signal and the first control signal when the backflow detection signal is at a low level.

The mode signal generating circuit has an input signal to select any of PWM fixing control to always generate a mode signal indicating the PWM control mode and automatic control to generate the mode signal indicating either the PFM control mode or the PWM control mode according to the backflow detection signal and the comparison signal.

A method of controlling a switching regulator configured to convert an input voltage into a predetermined output voltage using first and second switch elements series-connected between a voltage source of the input voltage and a terminal of a ground voltage, includes the steps of generating a ripple voltage signal having a voltage that increases when the first switch element is on and decreases when the second switch element is on, or a voltage that decreases when the first switch element is on and increases when the second switch element is on; comparing the ripple voltage signal to a first reference voltage, and generating a comparison signal indicating the comparison result; and generating, according to the comparison signal, a first control signal to switch on and off of the first switch element and a second control signal to switch on and off of the second switch element, and applying the first and second control signals to the first and second switch elements, respectively, wherein the step of generating the ripple voltage signal generates the ripple voltage signal based on the first and second control signals.

The step of generating the ripple voltage signal prepares third and fourth switch elements series-connected between the voltage source of the input voltage and the terminal of the ground voltage, and an integrating circuit including a first resistor element and a first capacitor series-connected between the terminal of the ground voltage and a node between the third and fourth switch elements, the integrating circuit configured to generate an integrated voltage by integrating a voltage at the node, and synchronizes on and off of the third and fourth switch elements with on and off of the first and second switch elements, respectively.

The step of generating the ripple voltage signal generates the ripple voltage signal by superimposing the integrated voltage on the voltage proportional to the output voltage.

The step of generating the ripple voltage signal prepares third and fourth switch elements series-connected between a voltage source of a second reference voltage and the terminal of the ground voltage, and an integrating circuit including a first resistor element and a first capacitor series-connected between the terminal of the ground voltage and a node between the third and fourth switch elements, the integrating circuit configured to generate an integrated voltage by integrating a voltage at the node, and synchronizes on and off of the third and fourth switch elements with on and off of the first and second switch elements, respectively.

Although the present invention has been described in terms of exemplary embodiments, it is not limited thereto. It should be appreciated that variations may be made in the embodiments described by persons skilled in the art without departing from the scope of the present invention as defined by the following claims.

What is claimed is:

1. A switching regulator configured to convert an input voltage into a predetermined output voltage using first and second switch elements series-connected between a voltage source of the input voltage and a terminal of a ground voltage, comprising:
a ripple generating circuit configured to generate a ripple voltage signal having a voltage that increases when the first switch element is on and decreases when the second switch element is on, or a voltage that decreases when the first switch element is on and increases when the second switch element is on;
a comparator configured to compare the ripple voltage signal to a first reference voltage, and generate a comparison signal indicating the comparison result; and
a switch element control circuit configured to generate, according to the comparison signal, a first control signal to switch on and off of the first switch element and a second control signal to switch on and off of the second switch element, and apply the first and second control signals to the first and second switch elements, respectively, wherein
the ripple generating circuit generates the ripple voltage signal based on the first and second control signals.

2. The switching regulator according to claim 1, wherein
the ripple generating circuit includes
third and fourth switch elements series-connected between the voltage source of the input voltage and the terminal of the ground voltage, and
an integrating circuit including a first resistor element and a first capacitor series-connected between the terminal of the ground voltage and a node between the third and fourth switch elements, the integrating circuit configured to generate an integrated voltage by integrating a voltage at the node, and
on and off of the third and fourth switch elements are synchronized with on and off of the first and second switch elements, respectively.

3. The switching regulator according to claim 2, wherein
the ripple generating circuit generates the ripple voltage signal by superimposing the integrated voltage on the voltage proportional to the output voltage.

4. The switching regulator according to claim 3, wherein
the ripple generating circuit includes
second and third resistor elements series-connected between a terminal of the output voltage and the terminal of the ground voltage, and
a second capacitor connected to a node between the first resistor element and the first capacitor and to a node between the second and third resistor elements, and
the ripple generating circuit generates the ripple voltage signal at the node between the second and third resistor elements by superimposing the integrated voltage through the second capacitor on the output voltage divided at the node between the second and third resistor elements.

5. The switching regulator according to claim 4, wherein
the ripple generating circuit includes a third capacitor in parallel with the second resistor element between the terminal of the output voltage and the node between the second and third resistor elements.

6. The switching regulator according to claim 1, further comprising:
a backflow detection circuit configured to generate a backflow detection signal indicating whether or not a backflow current is generated, which flows from a node between the first and second switch elements to the second switch element; and
a mode signal generating circuit configured to generate a mode signal indicating any of a PFM (Pulse Frequency Modulation) control mode and a PWM (Pulse Width Modulation) control mode according to the backflow detection signal and the comparison signal, wherein
consumption current of the circuits included in the switching regulator controlled based on the mode signal.

7. The switching regulator according to claim 6, wherein
the mode signal generating circuit includes a counter circuit configured to count rising edges or falling edges of the backflow detection signal, and
the mode signal generating circuit generates a mode signal indicating the PFM control mode when the counter circuit counts a predetermined number of rising edges or falling edges of the backflow detection signal.

8. The switching regulator according to claim 6, wherein
the mode signal generating circuit generates a mode signal indicating the PWM control mode at a predetermined point in time determined by the comparison signal and the first control signal when the backflow detection signal is at a low level.

9. The switching regulator according to claim 6, wherein
the mode signal generating circuit has an input signal to select any of PWM fixing control to always generate a mode signal indicating the PWM control mode and automatic control to generate the mode signal indicating either the PFM control mode or the PWM control mode according to the backflow detection signal and the comparison signal.

10. A switching regulator configured to convert an input voltage into a predetermined output voltage using first and second switch elements series-connected between a voltage source of the input voltage and a terminal of a ground voltage, comprising:
a ripple generating circuit configured to generate a ripple voltage signal having a voltage that increases when the first switch element is on and decreases when the second switch element is on, or a voltage that decreases when the first switch element is on and increases when the second switch element is on;
a comparator configured to compare the ripple voltage signal to a first reference voltage, and generate a comparison signal indicating the comparison result; and
a switch element control circuit configured to generate, according to the comparison signal, a first control signal to switch on and off of the first switch element and a second control signal to switch on and off of the second switch element, and apply the first and second control signals to the first and second switch elements, respectively, wherein
the ripple generating circuit generates the ripple voltage signal based on the first and second control signals, and
the ripple generating circuit includes
third and fourth switch elements series-connected between a voltage source of a second reference voltage and the terminal of the ground voltage, and
an integrating circuit including a first resistor element and a first capacitor series-connected between the terminal of the ground voltage and a node between the third and fourth switch elements, the integrating circuit configured to generate an integrated voltage by integrating a voltage at the node, and
on and off of the third and fourth switch elements are synchronized with on and off of the first and second switch elements, respectively.

11. The switching regulator according to claim 10, wherein
the ripple generating circuit generates the ripple voltage signal by superimposing the integrated voltage on the voltage proportional to the output voltage.

12. The switching regulator according to claim 11, wherein
the ripple generating circuit includes
second and third resistor elements series-connected between a terminal of the output voltage and the terminal of the ground voltage, and
a second capacitor connected to a node between the first resistor element and the first capacitor and to a node between the second and third resistor elements, and
the ripple generating circuit generates the ripple voltage signal at the node between the second and third resistor elements by superimposing the integrated voltage through the second capacitor on the output voltage divided at the node between the second and third resistor elements.

13. The switching regulator according to claim 12, wherein
the ripple generating circuit includes a third capacitor in parallel with the second resistor element between the terminal of the output voltage and the node between the second and third resistor elements.

14. The switching regulator according to claim 10, further comprising:
a backflow detection circuit configured to generate a backflow detection signal indicating whether or not a backflow current is generated, which flows from a node between the first and second switch elements to the second switch element; and
a mode signal generating circuit configured to generate a mode signal indicating any of a PFM (Pulse Frequency Modulation) control mode and a PWM (Pulse Width Modulation) control mode according to the backflow detection signal and the comparison signal, wherein
consumption current of the circuits included in the switching regulator is controlled based on the mode signal.

15. The switching regulator according to claim 14, wherein
the mode signal generating circuit includes a counter circuit configured to count rising edges or falling edges of the backflow detection signal, and
the mode signal generating circuit generates a mode signal indicating the PFM control mode when the counter circuit counts a predetermined number of rising edges or falling edges of the backflow detection signal.

16. The switching regulator according to claim 14, wherein
the mode signal generating circuit generates a mode signal indicating the PWM control mode at a predetermined point in time determined by the comparison signal and the first control signal when the backflow detection signal is at a low level.

17. The switching regulator according to claim 14, wherein
the mode signal generating circuit has an input signal to select any of PWM fixing control to always generate a mode signal indicating the PWM control mode and automatic control to generate the mode signal indicating either the PFM control mode or the PWM control mode according to the backflow detection signal and the comparison signal.

18. A method of controlling a switching regulator configured to convert an input voltage into a predetermined output voltage using first and second switch elements series-connected between a voltage source of the input voltage and a terminal of a ground voltage, comprising the steps of:
generating a ripple voltage signal having a voltage that increases when the first switch element is on and decreases when the second switch element is on, or a voltage that decreases when the first switch element is on and increases when the second switch element is on;
comparing the ripple voltage signal to a first reference voltage, and generating a comparison signal indicating the comparison result; and
generating, according to the comparison signal, a first control signal to switch on and off of the first switch element and a second control signal to switch on and off of the second switch element, and applying the first and second control signals to the first and second switch elements, respectively, wherein
the step of generating the ripple voltage signal generates the ripple voltage signal based on the first and second control signals.

19. The method according to claim 18, wherein the step of generating the ripple voltage signal prepares third and fourth switch elements series-connected between the voltage source of the input voltage and the terminal of the ground voltage, and an integrating circuit including a first resistor element and a first capacitor series-connected between the terminal of the ground voltage and a node between the third and fourth switch elements, the integrating circuit configured to generate an integrated voltage by integrating a voltage at the node, and synchronizes on and off of the third and fourth switch elements with on and off of the first and second switch elements, respectively.

20. The method according to claim 19, wherein
the step of generating the ripple voltage signal generates the ripple voltage signal by superimposing the integrated voltage on the voltage proportional to the output voltage.

21. The method according to claim 18, wherein the step of generating the ripple voltage signal prepares third and fourth switch elements series-connected between a voltage source of a second reference voltage and the terminal of the ground voltage, and an integrating circuit including a first resistor element and a first capacitor series-connected between the terminal of the ground voltage and a node between the third and fourth switch elements, the integrating circuit configured to generate an integrated voltage by integrating a voltage at the node, and synchronizes on and off of the third and fourth switch elements with on and off of the first and second switch elements, respectively.
